(19) United States
(12) Patent Application Publication
(10) Pub. No.: US 2003/0189550 A1
(43) Pub. Date: Oct. 9, 2003

(54) STATISTICAL RECORDER

(76) Inventor: RICHARD THOMAS ROSS, SILVERWATER (AU)

Correspondence Address: LADAS & PARRY, 26 WEST 61ST STREET, NEW YORK, NY, 10023, US

(21) Appl. No.: 09/122,193

(22) Filed: Jul. 23, 1998

(30) Foreign Application Priority Data
Jul. 28, 1997 (AU) PO 8256

(51) Int. Cl. G09G 5/00

(52) U.S. Cl. 345/168

(57) ABSTRACT

A system for collecting workflow statistics input by servers, the system including: a series of keyboard units each having a plurality of predetermined category keys for activation when a predetermined activity is undertaken by the servers, the keyboard units being interconnected to a central computer system; and a computer system connected to each of the series of keyboard units and adapted to exchange keyboard events with the keyboard units upon activation of the category keys and to produce reports based upon the exchanged keyboard events.

### FIELD OF THE INVENTION

The present invention relates to the automated collection of informative statistics in a workflow environment such as a customer service centre or the like.

### BACKGROUND OF THE INVENTION

In any customer service centre or the like, it is important to achieve high levels of productivity in addition to be able to monitor closely customer demands in order to ensure proper planning especially in relation to future requirements.

Previously, paper mechanisms have predominated for the collection of relevant statistics. Unfortunately, these mechanisms are unduly complicated and require a high degree of work in order to produce effective reports on the work carried out and demands and requirements.

### SUMMARY OF THE INVENTION

It is an object of the present invention to provide an improved form of statistical collection system in a service environment.

In accordance with a first aspect of the present invention there is provided a system for collecting workflow statistics input by servers, said system including:

a series of keyboard units each having a plurality of predetermined category keys for activation when a predetermined activity is undertaken by said servers, said keyboard units being interconnected to a central computer system;

a computer system connected to each of said series of keyboard units and adapted to exchange keyboard events with said keyboard units upon activation of said category keys and to produce reports based upon said exchanged keyboard events .

Preferably, the keyboard units include display units adapted to display current category and event information upon the occurrence of said keyboard events.

### BRIEF DESCRIPTION OF THE DRAWINGS

Notwithstanding any other forms which may fall within the scope of the present invention, preferred forms of the invention will now be described, by way of example only, with reference to the accompanying drawings in which:

FIG. 1 illustrates a typical customer service environment suitable for use with the present invention;

FIG. 2 illustrates the server tool of the present invention;

FIG. 3 illustrates the interconnection of a number of service tools in accordance with the preferred embodiment; and

FIG. 4 illustrates a schematic block diagram of the logic arrangement of a server tool 6 the preferred embodiment.

### DESCRIPTION OF PREFERRED AND OTHER EMBODIMENTS

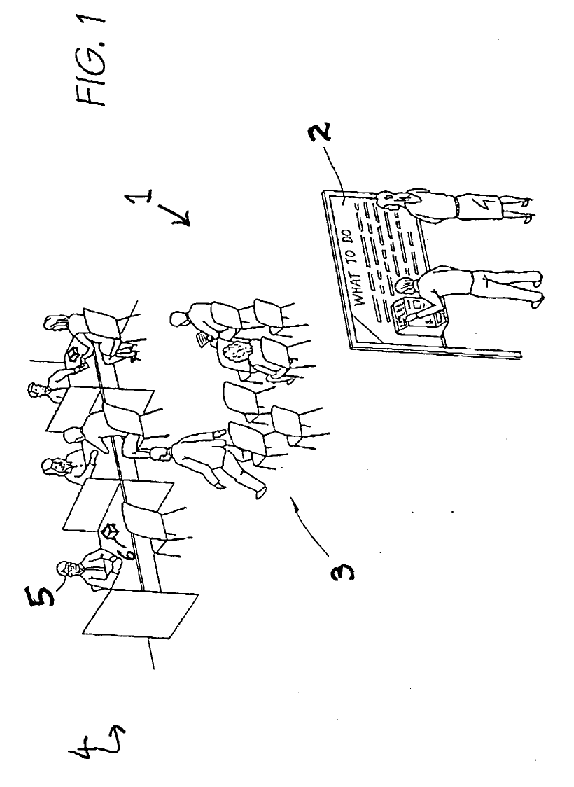

Referring now to FIG. 1, there is illustrated an example form of customer service centre 1 suitable for use in accordance with the present embodiment. It is assumed that, as is normally the case, customers arrive and are directed to a sign 2 which explains what to do and how to satisfy their particular requirements. Customers needing to utilise servers 5 of a service area 4 are instructed to wait in a waiting area 3 which may assume the structure of a queue waiting area or a sitting area as illustrated. Upon a spare server 5 being available within server area 4, a customer is directed to that server 5.

Each server 5 includes a server tool 6 which is designed to be activated by server 5 upon the occurrence of a significant event such as dealing with a new customer or the completion of a serving event.

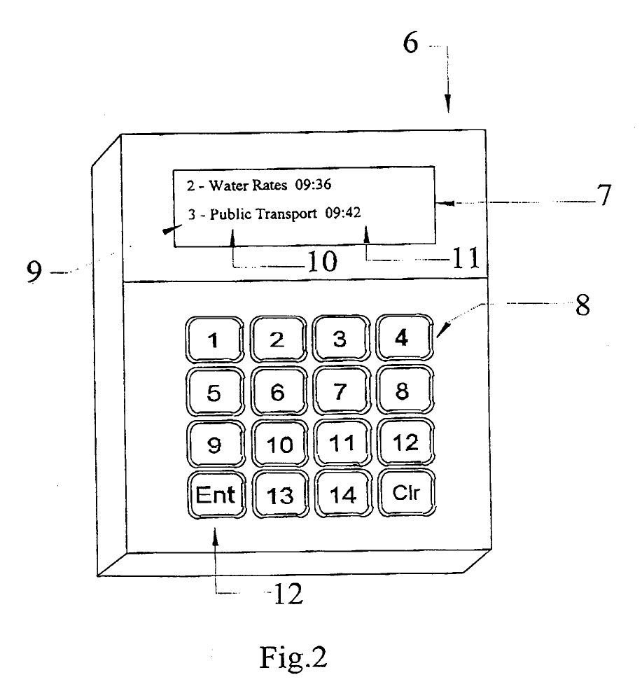

Referring now to FIG. 2, there is illustrated the server tool 6 in more detail. The server tool 6 is designed such that the work performed by servers 5 can be divided into a number of predetermined categories which are numerically itemised. Upon determining the category of the service required by a new customer, the corresponding key pad number 8 is depressed by the server followed by the enter key 12.

Upon depressing enter key 12, the LCD display 7 is updated to provide the corresponding information including depress key number 9, the corresponding category type 10 and time of input 11. Hence, throughout the day, as each new customer arrives, updated statistics are collected by the server tool 6.

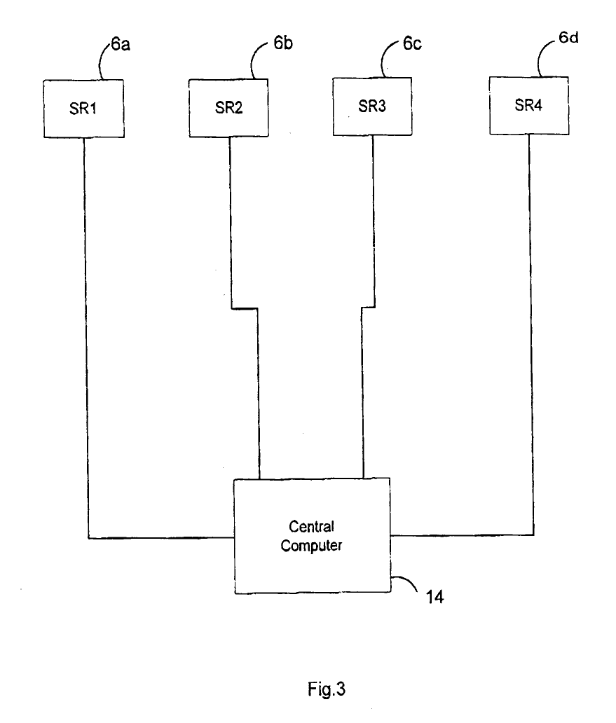

Referring now to FIG. 3, a series of server tools eg 6a-6d can be connected to and under the control of central computer 14. It will be evident to those skilled in the art that different forms of interconnection are possible including direct serial connection, daisy chain etc. Further, the intercommunication can be extended to wireless mechanisms such as wireless radio or infrared communications.

The central computer 14 can comprise a suitably programmed PC running Windows NT or the like. The central computer 14 interactively controls each of the server tools 6a-6d to update their displays and to download keyboard events.

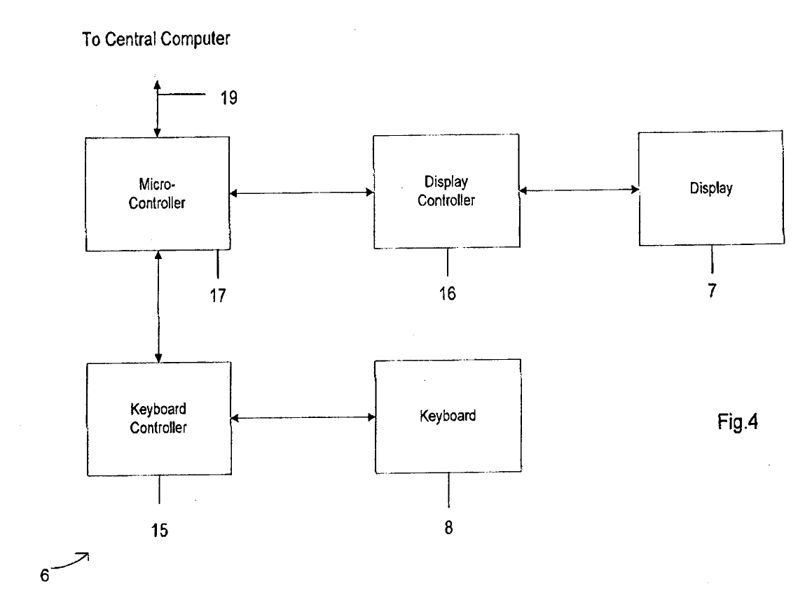

Referring now to FIG. 4 there is illustrated one form of functional layout of server tool 6. The server tool 6 can include the usual keyboard controller 15 and display controller 16 to control keyboard 8 and display 7 respectively. Each of these controllers in turn is under the control of microcontroller 17 which is assumed to have onboard memory for programming. The micro controller 17 is in turn connected to the central computer 14 by means of communication line 19.

The central computer 14 is suitably programmed to interface and monitor all events occurring on the server tools 6a-6d and to produce regular reports under the control of the usual graphical user interface. For example, the central computer 14 could be programmed in Visual C++ and lower level Assembly Language routines under a Microsoft Windows NT environment in the usual form to provide a summary of each server by category and by time over both hourly, weekly and monthly time intervals.

Further, the programming of the central computer can include a time based function to calculate all the serving times, waiting times and the categories chosen which can be analysed and include in generated reports.

It will be evident to those skilled in the art that many different forms of reports can be produced by server computer 14 or a central computer or remote supervisor station and printed out as required. The reports can include, but are not limited to:

number of customers/clients of each catergory per hour;

number of customers/clients per server;

serving times

waiting times

number of servers available, idle etc

averages, mean and other statistics

table, graphs, graphics etc.

Further, a number of refinements can be envisaged. For example, each keyboard can include an alert button which, when depressed by a server, provides a message to all adjacent servers that assistance may be required.

Further, it will be readily evident that other particular embodiments are possible. For example, the system could be implemented through the interconnection of a series of computers in a local area network (LAN) or a wider area network (WAN) to achieve a similar functionality. The category keys may be software created keys in a touch sensitive screen environment where the user is able to press a key and the system prompts an answer to questions such as ‘what category’, which then prompts further questions etc.

Further, other additional input means can be attached to each server tool 6. For example, magnetic strip card readers, processor (smart) card readers, bar code readers, token readers etc can be provided.

Further, a login facility can be provided with password identity access for a sever 5 initially using a server tool 6.

Each of the server tools 6 is further able to be utilized to record multiple categories of service for one customer or client with the system able to separately record categories and time for the same customer. Alternatively, in some cases it may be the case that only one category is relevant to the operational environment and statistics can be kept for this single category.

The teachings of the preferred embodiment can be readily adapted to other environments. For example, in a self service environment, the customer can be provided with the responsibility for pressing one of a predetermined number of category keys when they require a service. In a self service environment, the category keys may be formed on a touch sensitive display and recorded by a central computer system.

Further, the teachings of the preferred embodiment could be extended to an automated customer tracking system with customers passing through a series of check points with each check point registering a different category. The registration process can be by manual or automatic means. Preferably, at some check points customers are able to select from one of a series of categories by the activation of a keypad similar to that shown in FIG. 2.

It would be appreciated by a person skilled in the art that numerous variations and/or modifications may be made to the present invention as shown in the specific embodiment without departing from the spirit or scope of the invention as broadly described. The present embodiment is, therefore, to be considered in all respects to be illustrative and not restrictive.

We claim:

1. A system for collecting workflow statistics input by servers, said system including:
a series of keyboard units each having a plurality of predetermined category keys for activation when a predetermined activity is undertaken by said servers, said keyboard units being interconnected to a central computer system; and
a computer system connected to each of said series of keyboard units and adapted to exchange keyboard events with said keyboard units upon activation of said category keys and to produce reports based upon said exchanged keyboard events.

2. A system as claimed in claim 1 wherein said keyboard units include display units adapted to display current category and event information upon the occurrence of said keyboard events.

3. A system as claimed in claim 1 wherein said system is implemented on a network of computers.

4. A system as claimed in claim 3 wherein said network comprises a wireless local area network.

5. A system as claimed in claim 1 wherein said category keys include a series of distinct numbers or characters.

6. A system as claimed in claim 1 further comprising an external data input means for inputting data to said keyboard units, said input means comprising a magnetic card reader, a processor smart card reader, a bar code reader or other form of automated recognition means.

7. A system for collecting workflow statistics input by servers, said servers being automatically activated to determine a category input upon a user passing by said server, said system including:
a series of data input units each having a plurality of predetermined category inputs for activation when a predetermined activity is undertaken by said servers, said keyboard units being interconnected to a central computer system;
a computer system connected to each of said series of data input units and adapted to exchange data events with said data input units upon activation of said category keys and to produce reports based upon said exchanged data events.
